(19) United States
(12) Patent Application Publication
(10) Pub. No.: US 2022/0291958 A1
(43) Pub. Date: Sep. 15, 2022

(54) MOBILE PHONE OPERATING SYSTEM FOR MINORS AND ITS ARCHITECTURE AND ECOLOGICAL DEVELOPMENT METHOD

(71) Applicant: BEIJING CORE SYSTEM TECHNOLOGY CO., LTD., Beijing (CN)

(72) Inventor: Manliang YANG, Beijing (CN)

(73) Assignee: BEIJING CORE SYSTEM TECHNOLOGY CO., LTD., Beijing (CN)

(21) Appl. No.: 17/804,420

(22) Filed: May 27, 2022

Related U.S. Application Data
(63) Continuation of application No. PCT/CN2020/092498, filed on May 27, 2020.

(30) Foreign Application Priority Data
Nov. 29, 2019 (CN) 201911207529.X

(51) Int. Cl. G06F 9/48; G06F 9/54; G06F 9/455

(52) U.S. Cl. CPC G06F 9/4881; G06F 9/54; G06F 9/45558; G06F 2009/4557

(57) ABSTRACT

The present application proposes a mobile phone operating system architecture and a corresponding ecological development method. The mobile phone operating system includes: the operating system core layer, which is used to manage hardware devices and task scheduling, etc.; the subsystem management layer, which runs on the operating system kernel and is used to provide the necessary management functions for the operation of the subsystem; the subsystem, which runs on above the subsystem management layer, it is used to provide the running environment of the application components; the application program and its components run in the subsystem, and are used to provide specific functional services to the users of the mobile phone operating system. The mobile phone operating system architecture provided by this application can accommodate various existing or future mobile phone application ecosystems, and realize the perfect decoupling of mobile phone hardware and ecological software. The present application also provides a feasible mobile phone operating system ecological development strategy.

### CROSS REFERENCE TO RELATED APPLICATIONS

This application is a continuation of International application No. PCT/CN2020/092498, filed May 27, 2020, which claims priority of Chinese Patent Application No. 201911207529.X filed on Nov. 29, 2019, the contents of which are incorporated herein by reference.

### TECHNICAL FIELD

The present disclosure relates to the field of mobile Internet technology, a brand-new mobile phone operating system architecture design, and in particular to a mobile phone operating system for minors.

### BACKGROUND

In the existing mobile phone operating system, the function code of the operating system itself is highly coupled with the application layer code. At present, ecological software running on a certain operating system either cannot run on other operating systems, or a certain operating system loses its competitiveness and development space because it needs to be compatible with ecological software of other operating systems. The user's mobile phone cannot switch freely between ecological software of different operating systems.

### SUMMARY

The new mobile operating system architecture proposed in this application can provide efficient operation efficiency, facilitate the expansion of ecosystems and types of ecosystems, and can accommodate (note that it is not compatible) existing ecosystems, allowing anyone who wants to have an independent ecosystem. Groups and individuals can use the system freely, so that the ecosystem can be completely separated from the hardware carrier.

Solve the problem that it is difficult for a new operating system to form its own ecological environment.

Solve the problem that minors are directly or indirectly inseparable from mobile phones due to the needs of the teaching environment and the impact of the living environment, but also bear the influence of bad information on mobile phones; solve the problem that each family needs to spend a lot of money for the education of minors buy a lot of electronic products and are not easy to carry and unified management and other issues.

In order to solve the above technical problems, the present application proposes a brand-new operating system architecture, on which a mobile phone operating system for minors is provided. The operating system includes: a subsystem management layer, which runs on the operating system. Above the kernel, it is used to provide the necessary management functions for the operation of the subsystem; the subsystem, running on the management layer of the subsystem, is used to provide the running environment of the application component; the application component, running in the subsystem, is used for provide specific functional services to users of mobile phone operating systems.

In some embodiments, the subsystem can run in the cloud or locally on the phone.

In some embodiments, the implementation of the subsystem includes a virtual machine and a software container.

In some implementations, the application components can run in the cloud or locally on the mobile phone.

In some embodiments, the operating system kernel includes: a operating kernel.

In some embodiments, the subsystem management layer includes: control components and libraries, and display components.

In some embodiments, control components and libraries are used to perform the control functions of the subsystem management layer.

In some embodiments, the display component is used to perform the display function of the subsystem management layer.

In some implementations, a subsystem is specially oriented to minors, and the application component of the subsystem is an application component oriented to minors.

In some embodiments, the application components for minors include: application components for security protection, application components for education and learning, and application components for educational development.

In order to solve the above-mentioned technical problems, the present application proposes a mobile phone operating system ecological development method based on the above-mentioned mobile phone operating system framework, including: according to the mobile phone operating system framework, utilizing the ecological characteristics of mobile phone software in the field of minors, examples convert a minor-oriented subsystem to obtain a mobile phone operating system dedicated to minors; receive a switching instruction, wherein the switching instruction is used to instruct switching to a minor's mobile operating system; and according to the switching instruction, switch from an adult's mobile phone operating system to a minor's mobile phone operating system.

In some embodiments, the web browsing permission of the minor's mobile phone operating system is prohibited, and the network communication permission of the minor's mobile phone operating system is enabled.

After adopting such a design, the present application has at least the following advantages:

It realizes the inclusion of various ecological software by the mobile phone operating system in the future, and realizes the decoupling between the underlying code of the operating system and the upper-layer application logic through the subsystem management layer and the subsystems running on the subsystem management layer.

The mobile phone operating system for minors provided by the embodiments of the present application provides a reliable way for children to safely access the mobile phone and use the mobile phone to complete homework and improve education.

### BRIEF DESCRIPTION OF THE DRAWINGS

The above is only an overview of the technical solutions of the present application. In order to understand the technical means of the present application more clearly, the present application will be further described in detail below with reference to the accompanying drawings and specific embodiments.

FIG. 1 is a system architecture diagram of a mobile phone operating system provided by the present application.

### DETAILED DESCRIPTION

The preferred embodiments of the present application will be described below with reference to the accompanying drawings. It should be understood that the preferred embodiments described herein are only used to illustrate and explain the present application, but not to limit the present application.

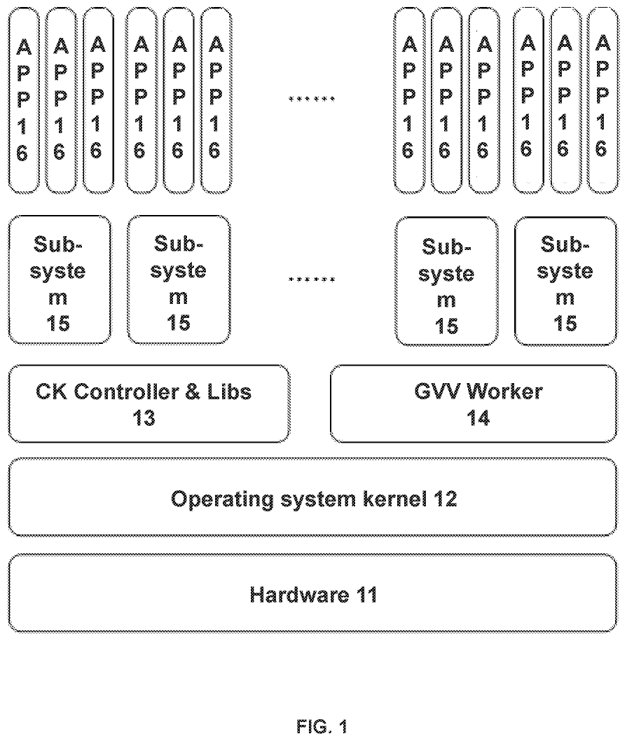

FIG. 1 shows the system architecture of the mobile phone operating system provided by the present application. Referring to FIG. 1, the mobile phone operating system runs on the system hardware 11, including: a subsystem management layer, a subsystem 15, and an application component 16 running in the subsystem.

The role of the subsystem management layer is to provide the necessary management functions for the operation of the subsystem. The subsystem management layer mainly includes: CK controller and library 13, and GVV worker 14.

The role of the subsystem 15 is to provide a running environment for the application components 16, to provide technical support for the mutual communication between different application components 16, and so on. The runtime environment is the interfaces and services necessary for the application component 16 to operate.

The application component 16 can be developed in different programming languages, as long as the relevant interfaces that must be implemented in the subsystem 15 are completed.

The core layer is the operating system kernel.

Above the operating system kernel is the subsystem management layer. The subsystem management layer contains all the content that needs to support the operation and management of the subsystem, which is mainly divided into control components and libraries; and separates display-related components to facilitate modular design and improve the efficiency of GPU and FrameBuffer.

Above the subsystem management layer are multiple subsystems that can be extended.

Above the subsystem is the application software running in a certain ecosystem of the subsystem.

The operating system kernel is responsible for interacting with the hardware, and supports and manages the operation of the subsystems through the subsystem management layer, but does not need to generate real-time scheduling for each subsystem, and only one subsystem 15 runs at the same time. However, the subsystem 15 can be switched freely and quickly, just like installing multiple operating systems, it can run software of different ecosystems. A subsystem is a system that can carry an independent mobile application ecological environment. Using open interface protocols, major manufacturers, organizations, institutions and even individuals can develop their own subsystems to run on this operating system to maintain or develop their own independent ecosystems. In this way, the division of resources in the software world will be clearer and more accurate, and the situation of wasting resources on repetitive things will be significantly improved. This open subsystem development strategy can make this operating system have the ability to embrace the application software ecosystem of the whole world, even including the ecosystem of Android and IOS. It is still necessary to pay attention to the difference between inclusiveness and compatibility here.

The operation of each subsystem can be downloaded locally to run, or it can be run in a distributed manner by using faster and faster mobile networks, that is, part of it runs locally, part of it runs in the cloud, and each part can be stored in the cloud, when needed, it can be dynamically downloaded to run locally, and then it can be killed. This can greatly reduce the burden on the mobile phone hardware and improve the operating efficiency of the system.

The ecosystem software carried by each subsystem, that is, the application layer software, can also run in a distributed manner, or can all run within the relevant subsystems to support outdated application software.

In the era of smart phones, how to keep minors away from the harm brought by the Internet and use network resources to learn and improve is a common concern of people. At the same time, there are minor electronic products that have been de-mobilized, such as smart watches, learning robots, learning machines, etc. Almost every family has to buy at least 3-4 similar products to meet their needs, and with the development of primary and junior high schools—the growth process of high school needs to be updated many times. High cost, low efficiency, and inconvenient to carry, they are more rigid than smartphones, and the hardware performance of these products is far less than that of smartphones that have been eliminated by adults. At the same time, the functions of electronic products for minors that have been removed from mobile phones can also be realized on smartphones, and the effect will be better, the maintenance and upgrading will be more convenient, and the educational resources will be more unified.

Using mobile phones that have been eliminated by adults to achieve these functions not only saves the cost of education for families, but also prolongs the service life of mobile phones, which can bring good social benefits.

According to the data of the sixth census, the number of minors in my country alone is 299.7 million, and the market space is broad.

From the above, first develop a subsystem for minors to form a complete operating system. Because of the purity of the ecological software in the minor mobile phone market, the ecosystem supported by this subsystem can and must be independent, bringing living space and ecological accumulation to the operating system of this application, and being unique in order to become a truly influential operating system. After accumulating a certain market and ecological environment and capital, it began to develop a subsystem for adults, forming a competition for Android and IOS. This way of entering into competition avoids the danger of direct competition with the old operating systems adopted by other industry giants, and has a feasible trajectory of ecological accumulation. The ecosystem of minors includes many fields such as security protection, education and learning, and educational development, which can accumulate capital while accumulating ecology. It can cooperate with mobile phone manufacturers to sell mobile phones, forming an absolute competitive advantage for products such as children's smart watches, learning machines and teaching robots. According to this method and idea, the creation and accumulation of the operating system ecological space of the present application will be very feasible, thus solving the problems that the new operating system ecology is difficult to establish and the application is difficult to promote.

At the same time, the stability and reliability of the system can also be verified by means of the operation and commercialization of subsystems for minors.

In the future, the subsystems that are not aimed at minors can easily be prevented from running in the architecture of this application, so as to prevent minors from entering the adult subsystem. It's also easier to switch between adults and minors on the same phone.

In order to avoid direct competition with the current mainstream operating systems, this application is based on the mobile phone operating system architecture provided by the above-mentioned embodiments, and utilizes the relatively pure characteristics of mobile phone software ecology in the field of minors. A mobile phone operating system dedicated to minors, develop independent ecological software on this operating system, and sell mobile phones specially designed for minors to protect minors and help their education and growth, so as to accumulate capital and verify the system architecture is stable and reliable. After maturity, it will open the subsystem development protocol, enter the field of adult mobile phones, and realize the switching between minors and adults on the same mobile phone according to the control of the subsystem.

The architectural design of this application makes the mobile phone ecosystem more diverse in a narrow sense. When the ecological type and scale based on the operating system reach a certain level, the ecosystem supported by a certain subsystem can no longer appear to be so super powerful, just like the world needs multi-polar development, which can make the ecological software industry more powerful and fairness.

The example of the mobile phone operating system for minors in this application can effectively help minors grow healthily and optimize learning resources, help each family to reduce educational expenses, and help the operating system of this application accumulate a considerable ecosystem.

The above are only preferred embodiments of the present application, and are not intended to limit the present application in any form. Those skilled in the art make some simple modifications, equivalent changes or modifications by using the technical contents disclosed above, all of which fall within the scope of the present application. within the protection scope of the application.

What is claimed is:

1. A mobile phone operating system architecture, is characterized in that, comprising:
operating system kernel;
the distributed processing coordination mechanism and distributed operation scheduling management layer based on mobile communication run on the operating system kernel;
the management layer of subsystems and similar subsystem architectures runs on top of the distributed operation scheduling management layer to provide the necessary management functions for the operation of the subsystem;
the subsystem runs on the subsystem management layer and is used to provide the operating environment of the application components; and
an application program and its components run in the subsystem and are used to provide specific functional services to users of the mobile phone operating system.

2. The mobile phone operating system architecture of claim 1, comprising:
the implementation of the subsystem includes a virtual machine and a software container.

3. According to claim 2, comprising:
the subsystems can be switched freely and quickly, and can run software of different ecosystems as if multiple operating systems are installed; the system kernel is responsible for interacting with the hardware, it supports and manages the operation of the subsystems through the subsystem management layer, but does not need to generate real-time scheduling for each subsystem, and only one subsystem runs at the same time.

4. The mobile phone operating system architecture of claim 2, comprising:
the subsystems can be developed by any organization or individual to support their own independent ecosystems according to the open protocol, so that ecological types can be inclusively expanded, and further support any number of subsystems, and the ecosystems and types of ecosystems can be expanded arbitrarily.

5. The mobile phone operating system architecture of claim 2, comprising:
multi-subsystem architecture support includes Android subsystem and IOS subsystem.

6. The mobile phone operating system architecture of claim 2, wherein the subsystem adopts a distributed architecture, and the operation mode of the subsystem includes at least one of distributed operation and complete local operation, and each subsystem adopts a distributed architecture, the operation of the system can be downloaded to the local area for operation, or it can be distributed by using the increasingly fast mobile network, that is, part of it runs locally, part of it runs in the cloud, and each part can be stored in the cloud, when needed, then dynamically downloaded to the local operation, and then can be eliminated, which can greatly reduce the burden of mobile phone hardware and improve the operating efficiency of the system.

7. The mobile phone operating system architecture of claim 1, wherein the subsystem management layer includes: a control component, a library, and a display component; the function of the subsystem management layer is to provide necessary management for the operation of the subsystem function; the subsystem management layer mainly includes: CK controller and library, as well as GVV workers, to separate display-related components, so as to facilitate modular design and improve the efficiency of GPU and FrameBuffer.

8. The mobile phone operating system architecture of claim 1, characterized in that it supports mobile communication.

9. A mobile phone operating system ecological development method using the mobile phone operating system architecture according to claim 1, comprising:
according to the mobile phone operating system architecture, using the ecological characteristics of mobile phone software in the field of minors, first instantiate the subsystems for minors to obtain a mobile operating system dedicated to minors, so as to accumulate ecology and verify the stability of the system architecture stability and reliability, avoid direct competition with the current mainstream operating systems, and then implement various subsystems in the adult field, which provides a practical and feasible way to solve the serious problem that the new operating system is difficult to survive and develop; a switching instruction, wherein the switching instruction is used to instruct switching to a minor's mobile phone operating system; and
according to the switching instruction, switching from an adult's mobile phone operating system to a minor's mobile phone operating system.

10. The mobile phone operating system for a minor of claim 9, wherein the web browsing authority of the minor's mobile phone operating system is prohibited, and the network of the minor's mobile phone operating system is activated communication authority; the subsystem layer for minors covers system functions such as time limit management, browser stripping and disabling.
